(19) United States
(12) Patent Application Publication
(10) Pub. No.: US 2009/0293819 A1
(43) Pub. Date: Dec. 3, 2009

(54) REMOTE WATER SHUT-OFF DEVICE

(76) Inventor: SANFORD B. WEISS, Los Angeles, CA (US)

Correspondence Address: STETINA BRUNDA GARRED & BRUCKER, 75 ENTERPRISE, SUITE 250, ALISO VIEJO, CA, 92656, US

(21) Appl. No.: 12/542,138

(22) Filed: Aug. 17, 2009

Related U.S. Application Data
(63) Continuation of application No. 11/714,305, filed on Mar. 6, 2007, now abandoned.

(51) Int. Cl. F22D 5/26; F16K 31/02

(52) U.S. Cl. 122/451 R; 251/129.15

(57) ABSTRACT

Described herein, is a device and system for remotely shutting off the supply of water to water heaters, thereby preserving a reservoir of potable water within the water heater during exigent times. An “off” signal may be sent within a region, thereby preventing the further flow of water into water heaters when the water supply has become contaminated. The device includes an antenna for receiving signals, a valve unit, and a solenoid capable of opening and closing the valve unit upon the receipt of “on” and “off” signals. The device may be battery operated and may sound a warning alarm when activated and/or when the batter is low. Also described, is a method of preserving a potable reservoir of water within a water heater upon the water supply leading to the water heater becoming contaminated.

### CROSS-REFERENCE TO RELATED APPLICATIONS

The present application is a continuation of U.S. patent application Ser. No. 11/714,305 entitled REMOTE WATER SHUT-OFF DEVICE filed Mar. 6, 2007, the teachings of which are incorporated herein by reference.

### STATEMENT RE: FEDERALLY SPONSORED RESEARCH/DEVELOPMENT

Not Applicable

### BACKGROUND

1. Field of the Invention

The present invention relates to a remote water shut-off device for a water heater. More particularly, the present invention relates to a water shut-off device that may be remotely activated by authorities in emergency situations in order to stop the continued inflow of water to the water heater tank.

2. Description of Related Art

Virtually all homes, apartments, commercial buildings and the like are typically provided with water heaters that are operative to provide a continuous reservoir of heated water, as may be needed for a variety of purposes. Water heater storage tanks typically vary in size from 20 gallons to 100 gallons, with 40 gallons being the most common size. Typically, the water stored within the water heater comes from a municipality and is generally contaminant free. Municipal water sources, however, may become contaminated during states of emergency, such as earthquakes, floods, acts of terrorism, acts of war, and the like.

During such emergencies it may be difficult, if not impossible, for potable water to be delivered to residences and/or places of business. The relatively large amount of water present in the water heater storage tank could serve as a reservoir of potable water during emergency situations. Although remotely controlled water supply shut-off systems are well known in the art, they are usually attached to the water main entering the building and therefore shut off the entire supply of water to the building. Additionally, these water shut-off valves are intended to be operated by an individual caretaker of the building to stop the inflow of water, for example when there is a leak discovered within said building.

Therefore, it would be beneficial to have a mechanism for only preventing the inflow of contaminated water into water heaters, as opposed to the entire building. Furthermore, it would be beneficial to have a system that would enable governmental authorities to remotely and quickly shut down the inflow of water to water heater tanks within a given area as need be without requiring action on part of individual building caretakers.

### BRIEF SUMMARY

The present invention contemplates a water shut-off device that can be controlled remotely to thus shut off any water source input providing water to an individual water heater to thus cut off any potentially contaminated water from entering the water heater tank, thereby isolating the water within the tank and preserving the water in its uncontaminated state. In one embodiment, the water shut-off device may include a remotely controlled solenoid valve that is operative to transition from an open state, allowing water to be input into a water heater, and a closed state, shutting off all input of water into the water heater upon receiving a signal.

Along these lines, it is contemplated that the signal may be a radio frequency (RF) signal that can be broadcast over a wide area to thus immediately provide for the shut off of water to water heaters within a given vicinity. For example, in case of an earthquake, act of terrorism, or other emergency that impedes the ability of a municipality to provide clean water to a community, an RF signal can be broadcast activating each solenoid coupled with each respective water heater to thus isolate and contain any existing reservoir of water with the water heater tank. Such shut off can be maintained for any duration of time until purified water can again be provided.

It is envisioned that the water shut-off device of the present invention will be installed inline at or near the water heater input. By doing so, water entry is only impeded at the water heater, as opposed to halting the entry of water to the entire building. As such, water may continue to be used in and around the building for purposes other than drinking, for example, watering yards, gardens, and plants, flushing toilets, and similar uses wherein the purity of the water is not critical. The water shut-off device of the present invention may be an integral part of a water heater, i.e., manufactured so as to be permanently installed at the hot water heater entrance. Alternatively, the water shut-off device may be an optional accessory that can be installed on any water heater unit by placing the device inline of the water flow at or near the entrance to the water heater.

In accordance with the present invention, there is provided a remotely controllable water shut-off device which includes a housing having an inlet for receiving water from an external water source and an outlet for conveying water to the water heater unit. The water shut-off device further includes an externally mounted antenna capable of receiving RF signals, an internally mounted solenoid capable of receiving a further signal communicated from the antenna upon receiving an RF signal, and a power supply source. The power supply source enables the solenoid to move an internally mounted valve between open and closed positions upon receiving “on” and “off” RF signals, respectively.

When the municipal water supply has been contaminated, authorities can send an “off” RF signal within the locale serviced by the water supply. The antenna of the water shut-off device is adapted to receive such an “off” RF signal and transmit a signal to the solenoid in order to close the valve of the device, thereby stopping the inflow of water to the water heater. When the water supply has again been determined to be safe for consumption, authorities can send an “on” RF signal within the locale serviced by the water supply. Upon receiving such an “on” signal, the antenna transmits a signal to the solenoid in order to open the valve, thereby restoring the inflow of water to the water heater.

It is contemplated that the solenoid may directly open and close the main valve of the device, thereby directly starting and stopping the flow of water to the attached water heater. However, the solenoid may instead control a secondary pilot valve, whereby the water pressure itself then opens or closes the main valve as required by the device. The benefit of using a secondary pilot valve is that very little power is required to control the pilot valve, as opposed to the main valve. Accordingly, a pilot valve embodiment may be operated by a power supply consisting only of a low power, long-life battery.

### BRIEF DESCRIPTION OF THE DRAWINGS

These and other features and advantages of the various embodiments disclosed herein will be better understood with respect to the following description and drawings, in which like numbers refer to like parts throughout, and in which:

These and other features and advantages of the various embodiments disclosed herein will be better understood with respect to the following description and drawings, in which like numbers refer to like parts throughout, and in which:

FIG. 1 is a schematic side elevation view of a water shut-off device constructed in accordance with the present invention installed at the water entry point of a water heater;

FIG. 2 is a cross-sectional view of one embodiment of the water shut-off device of the present invention, wherein the device is in an “open” position, thereby allowing the flow of water through the device; and

FIG. 3 is a cross sectional view of the water shut-off device shown in FIG. 2, wherein the device is in a “closed” position, thereby preventing the flow of water through the device.

### DETAILED DESCRIPTION

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

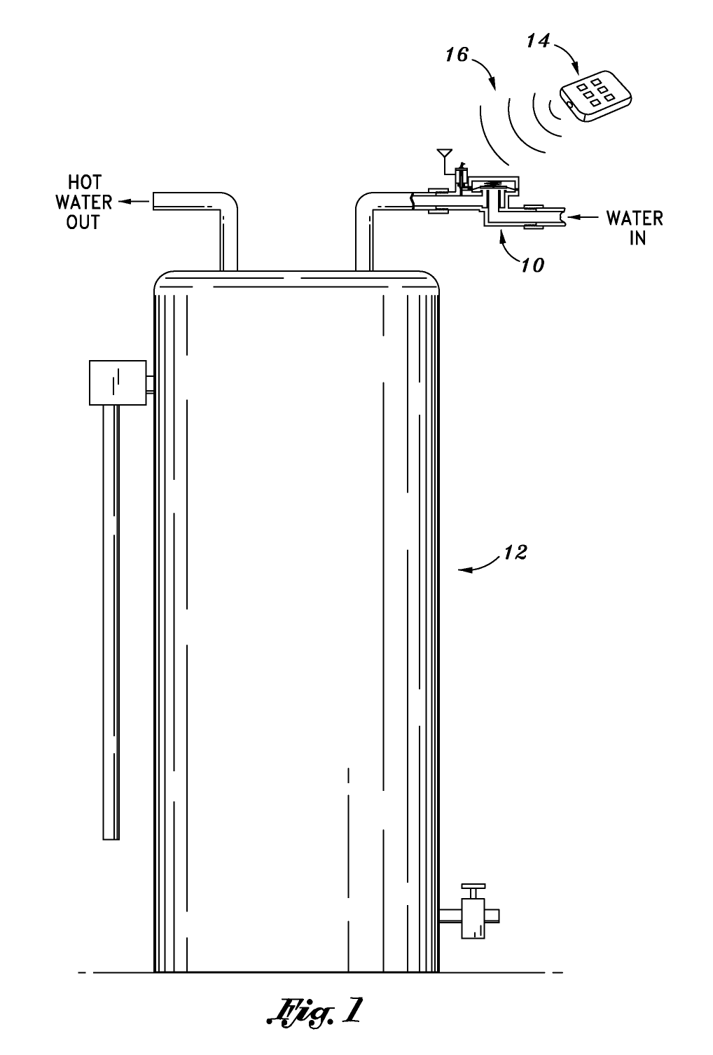

FIG. 1 shows one embodiment of the present invention, i.e., a remotely controllable water shut-off device 10 installed at the inlet of a water heater 12. Also shown in FIG. 1 is a remotely located transmitter 14 capable of sending signals 16 to the water shut-off device 10. 13. One embodiment of the present invention contemplates a system for remotely shutting off the flow of water from an external water supply to a water heater 12. A remotely located transmitter 14 may broadcast a shut-off signal 16 within a region served by the water supply, thereby stopping the flow of water to a plurality of water heaters 12 located within the region that are equipped with a water-shut off device 10 of the present invention. For example, the signals 16 sent by the remotely located transmitter 14, may be RF signals capable of being broadcast over a wide area, thereby allowing all of the water shut-off devices 10 within a given region to stop the supply of water to the attached water heaters 12. This shut-off signal 16, may be sent by governmental authorities and/or the water provider. The shut-off signal 16 will preferentially be sent in times of emergency. For example, if the water supply is contaminated by natural forces, such as an earthquake, floods, or the like, or by human causes, such as acts of terrorism, acts of war, pollutant dispersal, and the like, the shut-off signal 16 may be sent in order to maintain a supply of potable water within the water heater 12. Alternatively, if the supply of water is disrupted, for example, if water lines are destroyed, the shut-off signal 16 may be sent in order to maintain a reservoir of usable water to help sustain occupants until the supply of water can be restored.

The system of the present invention includes a remotely located transmitter 14 capable of sending “off” and “on” signals, and a water shut-off device 10 located at or near the inlet of a water heater 12. The water shut-off device 10 includes a substantially sealed housing 18, a valve unit 20, an antenna 22, a solenoid 24, and a power supply source 26. The substantially sealed housing 18 has an inlet 28, an outlet 30, and a fluid tight chamber 32 disposed between and in fluid communication with the housing inlet 28 and the housing outlet 30. Mounted to the housing inlet 28, is an inlet pipe 34 which is fluidly connected to the external water supply. Mounted to the housing outlet 30, is an outlet pipe 36 which is fluidly connected to the water heater 12. The valve unit 20 is disposed within the housing chamber 32 between the housing inlet 28 and the housing outlet 30. The antenna 22 is typically mounted externally on the housing 18 and is capable of receiving the “off” and “on” signals 16 transmitted by the remotely located transmitter 14. Upon receiving either an “off” or “on” signal 16, the antenna 22 henceforth communicates a corresponding action signal to the solenoid 24. The solenoid 24 is typically mounted within the housing 18 and is capable of receiving the action signal communicated from the antenna 22. The power supply source 26 is connected to and capable of providing electrical energy to both the antenna 22 and the solenoid 24.

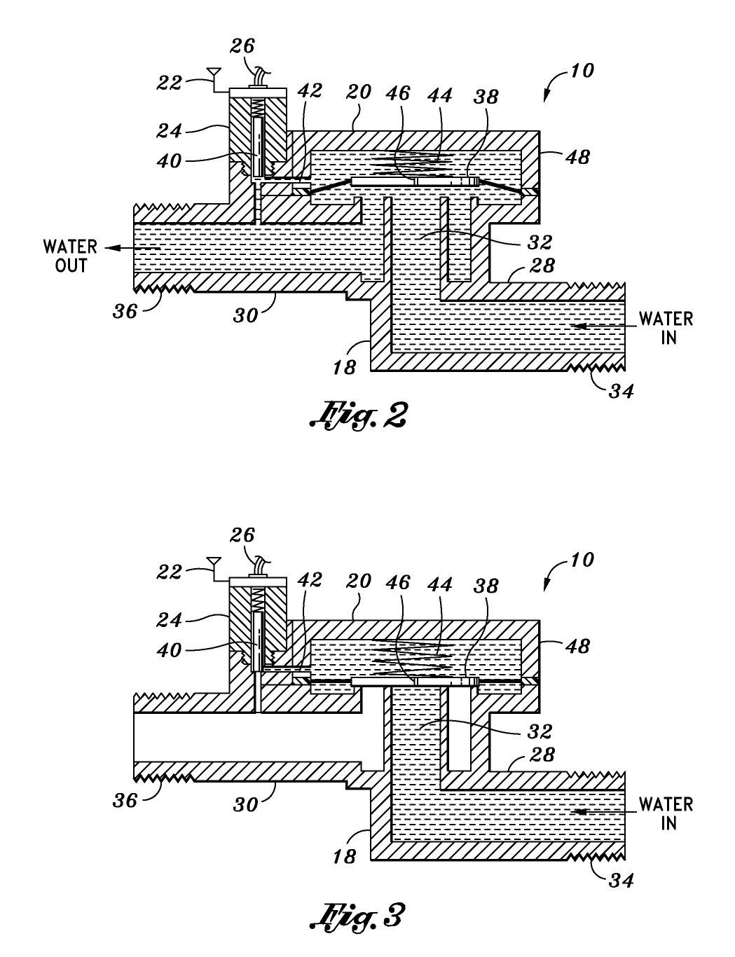

When the antenna 22 receives an “off” signal 16, the solenoid 24 actuates the valve unit 20 to a closed position, as shown in FIG. 3. When the valve unit 20 is in the closed position, the flow of water through the water shut-off device 10 into the water heater 12 is prevented. Upon the antenna 22 receiving an “on” signal 16, the solenoid 24 actuates the valve unit 20 to an open position, as can be seen in FIG. 2. When the valve unit 20 is in the open position, the flow of water through the water shut-off device 10 to the water heater 12 is restored.

The water shut-off device 10 shown in FIGS. 1-3 illustrates a valve unit 20, which includes both a main valve 38 and a pilot valve 40. In this embodiment, the solenoid 24 directly actuates the movement of the pilot valve 40 between open and closed positions. That is, when the water shut-off device 10 receives an “off” signal 16 from the remotely located transmitter 14, the solenoid 24 actuates the pilot valve 40 to a closed position. Further, when the water shut-off device 10 receives an “on” signal 16 from the remotely located transmitter 14, the solenoid 24 actuates the pilot valve 40 to an open position. As can be seen in FIG. 2, when the pilot valve 40 is in an open position water may flow through a pressure relief conduit 42. When water flows through the pressure relief conduit 42, the back-pressure on the main valve 38 is minimized, thereby allowing the pressure from the incoming water to open the main valve 38. This is the normal operating state, wherein water is allowed to flow through the water shut-off device 10 to the attached water heater 12. Upon receiving an “off” signal, however, the solenoid 24 actuates the pilot valve 40 into a closed position, thereby stopping the flow of water through the pressure relief conduit 42. At this point, the back-pressure increases, thereby allowing a spring 44 attached to the main valve 38 to press the main valve 38 into a closed position, stopping the flow of water through the water shut-off device. The main valve 38 contains a pinhole 46, which allows a small amount of water to flow through the main valve 38, even when in a closed position, into a pressure chamber 48. This pinhole 46 allows the pressure chamber 48 to fill even when the main valve 38 is in a closed position, thereby equalizing the pressure on both sides of the main valve 38 and maintaining the closed position of the main valve 38. When the pilot valve 40 again returns to an open position, the water in the pressure chamber 48 is able to flow through the pressure relief conduit 42. This results in a decrease in the back-pressure, and again allows the main valve 38 to move to an open position.

The benefit of using a valve unit 20 with a pilot valve 40 is that much less electrical energy is required to close the main valve 38, as opposed to a valve unit 20 wherein the solenoid 24 directly actuates the main valve 38. This would allow the water shut-off device to, for example, operate with only a battery as the power supply source 26.

In that regard, the power supply source 26, may be any source of electrical energy. For example, the power supply source 26 may be an AC source or a DC source. Furthermore, the power supply source 26 may be a battery, thereby negating the need for the device 10 to be wired to the electrical wiring of the building in which the water heater 12 is located. If, however, the water shut-off device 10 is wired to an AC power supply source, the device 10 may further include a secondary power supply source 50 (not shown). This secondary power supply source 50 may be a battery. Preferentially, the secondary power supply source 50 may be a rechargeable battery that is capable of being recharged by the AC power supply source 26. In this embodiment, the antenna 22 and solenoid 24 may be powered by either the power supply source 26 or the secondary power supply source 50. For example, the device 10 may preferentially be powered by the AC power supply source 26; however, if the AC power supply source 26 is interrupted (such as during a power outage), the device 10 may then be powered by the secondary power supply source 50.

The water shut-off device 10 may further include an audible alert alarm 52 (not shown). This audible alert alarm 52 may sound an intermittent alarm when the valve unit 20 is in a closed position. As such, the audible alert alarm 52 would function to alert occupants of the building that the supply of water to the water heater 12 has been stopped, thereby allowing the occupants to reduce their water consumption to preserve their supply of potable water and/or to only consume household water from the water heater 12, until the alarm has stopped and the supply of water to the water heater 12 has resumed. Additionally, or alternatively, the audible alert alarm 52 may sound an intermittent alarm when the attached battery is running low, thereby alerting the occupants of a need to replace the battery with a fresh, fully charged battery.

Another embodiment of the present invention includes a method of preserving a potable source of water in a water heater when the water supply to the water heater has become contaminated. The method includes placing a remotely controllable shut-off device at the water supply entry point of the water heater. The remotely controllable shut-off device is capable of closing an internal valve upon receiving an “off” signal. The method further includes transmitting an “off” signal to the remotely controllable shut-off device.

The “off” signal may be broadcast over a region supplied by the contaminated water supply, so that all water heaters in the region having the shut-off device installed will have their supply of water interrupted upon the “off” signal being broadcast. The “off” signal may be an RF signal that is capable of being broadcast over a large area. The “off” signal may be transmitted by a government body upon discovering an incident that has contaminated the water supply. Alternatively, or additionally, the “off” signal may be transmitted by the water supplier itself, upon discovering that the water supply has been contaminated or that the delivery of water has been disrupted. Additionally, an “on” signal may be transmitted after the water supply has been decontaminated, thereby allowing the flow of water to resume to water heaters within the given region. After receiving the “off” signal, the water shut-off device may emit an intermittent warning signal to alert the users of the water that the supply of water to the water heater has been stopped, thereby allowing the users to conserve their use of water until the alarm has stopped and water flow has resumed.

The above description is given by way of example, and not limitation. Given the above disclosure, one skilled in the art could devise variations that are within the scope and spirit of the invention disclosed herein, including various ways of stopping the flow of water though the water shut-off device 10. For example, although the valve unit 20 has been illustrated with both a main valve 38 and a pilot valve 40, it is further contemplated that the valve unit could be operational without the pilot valve 40. In this embodiment, the solenoid 24 would directly actuate the main valve 38. In such a device 10 lacking a pilot valve 40, when the antenna 22 receives an “off” signal 16, the solenoid 24 would directly actuate the main valve 38 to the closed position, and when the antenna 22 receives an “on” signal 16, the solenoid 24 would directly actuate the main valve 38 to the open position.

Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A device for remotely shutting off the flow of water from an external water supply to a water heater, the device comprising:
a substantially sealed housing having an inlet, an outlet, and a fluid tight chamber disposed between and in fluid communication with said inlet and said outlet;
an inlet pipe mounted to the housing inlet, said inlet pipe operable to allow fluid communication between the external water supply and the housing chamber;
an outlet pipe mounted to the housing outlet, said outlet pipe operable to allow fluid communication between the housing chamber and the water heater;
a valve unit disposed within the housing chamber between the housing inlet and the housing outlet;
an antenna capable of receiving an externally transmitted first signal and henceforth communicating a corresponding second signal;
a solenoid capable of receiving the second signal communicated from the antenna; and
a power supply source connected to and capable of providing electrical energy to the antenna and the solenoid,
wherein, upon the antenna receiving a first “off” signal, the solenoid actuates the valve unit to a closed position, thereby preventing the flow of water through the device, and wherein, upon the antenna receiving a first “on” signal, the solenoid actuates the valve unit to an open position, thereby restoring the flow of water through the device.

2. The device of claim 1, wherein the valve unit comprises a main valve;
wherein upon receiving the “off” signal, the solenoid directly actuates the main valve to the closed position; and
wherein upon receiving the “on” signal, the solenoid directly actuates the main valve to the open position.

3. The device of claim 1, wherein the valve unit comprises a main valve and a pilot valve;
wherein upon receiving the “off” signal, the solenoid directly actuates the pilot valve to a closed position; and
wherein upon receiving the “on” signal, the solenoid directly actuates the pilot valve to an open position.

4. The device of claim 1, wherein the external first signal is an RF signal.

5. The device of claim 1, wherein the power supply source is an AC source.

6. The device of claim 5, further comprising a secondary power supply source, wherein the secondary power supply source is a rechargeable battery, said rechargeable battery capable of being recharged by the AC source.

7. The device of claim 1, wherein the power supply source is a DC source.

8. The device of claim 7, wherein the power supply source is a battery.

9. The device of claim 1, further comprising an audible alert alarm.

10. The device of claim 9, wherein the audible alert alarm sounds intermittently when the valve unit is in a closed position.

11. The device of claim 8, further comprising an audible alert alarm.

12. The device of claim 11, wherein the audible alert alarm sounds when the battery is low.

13. A system for remotely shutting off the flow of water from an external water supply to a water heater, the system comprising:
a remotely located transmitter capable of sending “off” and “on” signals; and
a water shut-off device, said water shut-off device comprising:
a substantially sealed housing having an inlet, an outlet, and a fluid tight chamber disposed between and in fluid communication with said inlet and said outlet;
an inlet pipe mounted to the housing inlet, said inlet pipe fluidly connected to the external water supply;
an outlet pipe mounted to the housing outlet, said outlet pipe fluidly connected to the water heater;
a valve unit disposed within the housing chamber between the housing inlet and the housing outlet;
an antenna capable of receiving the “off” and “on” signals from the remotely located transmitter and henceforth communicating a corresponding action signal;
a solenoid capable of receiving the action signal communicated from the antenna; and
a power supply source connected to and capable of providing electrical energy to the antenna and the solenoid,
wherein, upon the antenna receiving an “off” signal, the solenoid actuates the valve unit to a closed position, thereby preventing the flow of water through the device into the water heater, and wherein, upon the antenna receiving an “on” signal, the solenoid actuates the valve unit to an open position, thereby restoring the flow of water through the device to the water heater.

14. The system of claim 13, wherein the “off” and “on” signals transmitted by the remotely located transmitter are RF signals.

15. The system of claim 14, wherein the remotely located transmitter is capable of sending the RF signals to multiple water shut-off devices located within an area serviced by the external water supply.

16. The system of claim 13, wherein the valve unit comprises a main valve;
wherein upon receiving the “off” signal, the solenoid directly actuates the main valve to the closed position; and
wherein upon receiving the “on” signal, the solenoid directly actuates the main valve to the open position.

17. The system of claim 13, wherein the valve unit comprises a main valve and a pilot valve;
wherein upon receiving the “off” signal, the solenoid directly actuates the pilot valve to a closed position; and
wherein upon receiving the “on” signal, the solenoid directly actuates the pilot valve to an open position.

18. The system of claim 13, wherein the power supply source is an AC source.

19. The system of claim 18, the water shut-off device further comprising a secondary power supply source, wherein the secondary power supply source is a rechargeable battery, said rechargeable battery capable of being recharged by the AC source.

20. The system of claim 13, wherein the power supply source is a DC source.

21. The system of claim 20, wherein the power supply source is a battery.

22. The system of claim 13, the water shut-off device further comprising an audible alert alarm.

23. The system of claim 22, wherein the audible alert alarm sounds intermittently when the valve unit is in a closed position.

24. The system of claim 21, the water shut-off device further comprising an audible alert alarm.

25. The system of claim 24, wherein the audible alert alarm sounds when the battery is low.

26. A method of preserving a potable source of water in a water heater upon the water supply to the water heater becoming contaminated, the method comprising:
placing a remotely controllable shut-off device at the water supply entry point of the water heater, wherein said remotely controllable shut-off device is capable of closing an internal valve upon receiving an “off” signal; and
transmitting an “off” signal to the remotely controllable shut-off device.

27. The method of claim 26, wherein the “off” signal is transmitted by a government body.

28. The method of claim 26, wherein the “off” signal is transmitted by the water supplier.

29. The method of claim 26, wherein the “off” signal may be transmitted over the region served by the contaminated water supply.

30. The method of claim 26, wherein the “off” signal is an RF signal.

31. The method of claim 26, wherein upon receiving the “off” signal the remotely controllable shut-off device emits an intermittent warning signal.
